(19) United States
(12) Patent Application Publication
(10) Pub. No.: US 2002/0107029 A1
(43) Pub. Date: Aug. 8, 2002

(54) Method and apparatus for obtaining location zone data for a mobile subscriber unit

(76) Inventors: Jack Ray Caughran, Aurora, IL (US); Dennis Frederick Daum, Bexley, OH (US); Gary Wayne Ritter, LaGrange Park, IL (US); Neil Howard York, Birmingham (GB)

Correspondence Address: Reginald J. Hill, Suite 1402, 19 South LaSalle Street, Chicago, IL, 60603, US

(21) Appl. No.: 09/777,204

(22) Filed: Feb. 5, 2001

(51) Int. Cl. H04Q 7/20

(52) U.S. Cl. 455/456; 455/422

(57) ABSTRACT

A wireless telecommunications system (100) includes a service control point (108) that implements a geographical interface that permits applications to request and receive geographical zone data for a mobile unit (101). The request (300) for geographical zone data identifies the mobile unit (302) and the type of zone requested (304). A zone manager (204) receives the request and communicates the request to a location manager (202). The location manager (202) is coupled to a position determination equipment (110) to determine a location of the mobile unit. The location manager returns the location of the mobile unit to the zone manager. The zone manager uses the location of the mobile unit, the zone type requested and a database of predefined zones to determine a zone for the current location of the mobile unit. The zone of the mobile unit is returned to applications via a response (400).

### FIELD OF THE INVENTION

The invention generally relates to obtaining location information for a mobile subscriber unit in a telecommunications network, and in particular, to obtaining geographical zone information on a mobile subscriber unit for use in telecommunications based applications.

### BACKGROUND OF THE INVENTION

The United States government recently mandated that wireless telecommunication service providers, and hence their networks, include the capability to locate a mobile subscriber unit within a certain geographical area of about 50 to 125 meters. Several technologies have emerged and are being developed to meet the government mandate, including, navigational systems such as the global positioning system (“GPS”), wireless assisted GPS, angle of arrival, time difference of arrival, RF Fingerprinting and enhanced forward link triangulation. These technologies offer various degrees of accuracy and technological superiority in locating a mobile subscriber unit. Concurrent with the emergence of these position determination technologies, several standards have emerged and are being developed for obtaining location information. The ANSI41 TR45.2 standards committee that is examining the issues and technologies for meeting the FCC Phase II mandate for E911 has concluded that the basic functionality necessary to implement Phase II should use non-call path associated signaling in order to meet all 911 situational contingencies and be implemented in the intelligent network on a service control point. The standards committee has left undefined the application that must reside on the service control point to control the call and complete the task required by the FCC mandate. More specifically, the standards committee has left undefined the protocol and content of information necessary to be exchanged to meet the FCC's mandate. The FCC mandate principally requires sending the mobile unit's position and call back number to a public safety answering point or emergency call center.

An exemplary application for interfacing with position determination equipment and providing location information for a mobile subscriber unit as mandated by the FCC is the Wireless 9-1-1 application from SignalSoft Corporation of Boulder, Colo. During the course of a call from a mobile subscriber unit the SignalSoft application provides x, y coordinate information (i.e., latitude and longitude) for the mobile subscriber unit. The x, y coordinate information is typically accurate within a radius of uncertainty. Although, adequate for wireless E 911 mandated service, the x, y coordinate information provided by Wireless 9-1-1 is otherwise of limited utility. Given the requirement of placing location determination equipment in the network infrastructure, it is desirable to leverage the location information to provide additional services. More specifically, these additional services include location sensitive billing services and enhanced services and tracing information based on location. Current location based applications are limited in their ability to provide a universal interface and standard information content for use in enabling additional services for location.

Therefore, a need exists for a method and apparatus for obtaining location information in a manner to support universally a wide variety of location enhanced telecommunication services.

### SUMMARY OF THE INVENTION

In accordance with the present invention, a method is provided for obtaining geographical zone data for a mobile subscriber unit. First a request is received for geographical zone data for the mobile subscriber unit. The request includes a mobile subscriber identifier that identifies the particular mobile subscriber unit for which geographical zone data is requested. The request also includes a zone type that identifies a type of predetermined geographical area, for example, a state, country, zip code type zone or other geographical area, including an arbitrarily defined area. A reply to the request is then returned. The reply includes zone based geographical data for the mobile subscriber including a zone identifier that identifies a current geographical area of the mobile subscriber unit. The current geographical area is of the zone type that was included in the request, for example, a state, country or zip code type. Preferably, the request for geographical zone data identifies the mobile switching center currently serving the mobile subscriber unit, if the identity of the mobile switching center is known. Also, the request for geographical zone data and the reply to the request are preferably transaction control application protocol (TCAP) messages. The request and reply are carried over standard networks, for example an Internet protocol network or a Signaling System 7 network. An apparatus for implementing the method described above is also provided.

### BRIEF DESCRIPTION OF THE DRAWINGS

FIG. 1 is a block diagram of a wireless telecommunications system including an interface for providing geographical zone data in accordance with the present invention.

FIG. 2 is a block diagram of a preferred embodiment of a service control point of the system of FIG. 1, wherein the service control point includes an interface for providing geographical zone data in accordance with the present invention.

FIG. 3 is a chart illustrating a zone query for requesting geographical zone data in accordance with the present invention.

FIG. 4 is a chart illustrating a zone reply that is delivered in response to a request for geographical zone data in accordance with the present invention.

FIG. 5 is a flow chart illustrating a method for requesting, providing and receiving geographical zone data in accordance with the present invention.

### DETAILED DESCRIPTION OF THE PREFERRED EMBODIMENTS

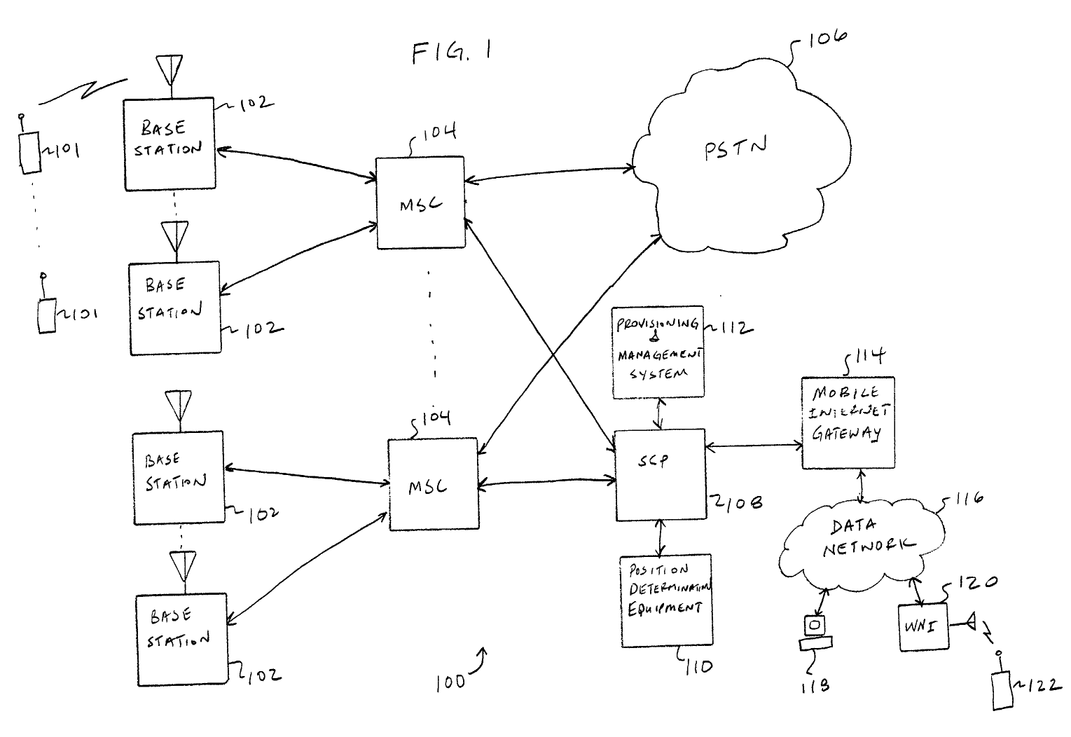

FIG. 1 is a block diagram of a wireless telecommunications system 100 in accordance with the present invention. Wireless telecommunications system 100 allows mobile communications units to communicate with each other and other units that are connectable to the wireless telecommunications system or public telephone network. System 100 includes mobile units 101, base stations 102 and mobile switching centers 104. Mobile units 101 communicate with base stations 102 via a wireless or over-the-air interface. As the name suggests, mobile units 101 are portable and move from location to location. Base stations 102 include an over-the-air or wireless interface for communicating with mobile units 101. Also, base stations 102 include an interface and link for communicating with mobile switching centers 104. Mobile switching centers 104 coordinate, establish and maintain communications with base stations 102 and provide an interface to the public switched telephone network (PSTN) 106. More specifically, mobile units 101 are coupled to the public switched telephone network 106 by virtue of the interfaces provided by base station 102 and mobile switching centers 104.

In accordance with the present invention, system 100 includes equipment for provisioning and determining geographical zone information for a particular mobile unit associated with system 100. In the preferred embodiment shown in FIG. 1, system 100 includes a service control point 108, position determination equipment 110 and a provisioning management system 112. Service control point 108 includes the functionality commonly associated with this well-known element of telecommunications systems, such as service logic, service data, and an SS7 interface. In addition, in accordance with the invention, SCP 108 includes an interface for permitting zone queries and returning geographical zone information. To determine the actual location of a mobile unit 101, positioning determination equipment (PDE) 110 uses one or more location determination technologies to determine geographical coordinates for a pinpoint location of the mobile unit. PDE 110 is coupled to SCP 108 to provide geographical coordinates of a mobile unit to facilitate determination of zone information by SCP 108. Provisioning management system 112 provides a user interface for provisioning zone information and managing the applications that provide zone information on SCP 108.

In addition to interfaces to mobile switching centers 104 and other elements of the public switched telephone network 106, SCP 108 includes an interface to a mobile Internet gateway 114. Mobile Internet gateway 114 is coupled to the data network 116, which is, for example, the Internet. Mobile Internet gateway 114 provides an interface for communication between elements on data network 116 and mobile units 101 or other elements in communication with system 100. Data network 116 is shown in FIG. 1 with a computer 118 coupled to it. In addition, a wireless network interface 120 is shown coupled to data network 116. Th wireless network interface 120 communicates with mobile data devices 122, such as personal digital assistants and the like.

Mobile units 101 are any communications devices, such as personal digital assistants, wireless telephones, or communications equipped computers. Preferably, mobile units 101 are wireless telephones that communicate via a known wireless telephone standard, such as CDMA (IS95), TDMA, and GSM.

Base stations 102 are any suitable base stations for communicating with mobile units 101. Preferably, base stations 102 communicate with mobile units 101 and mobile switching centers 104 in accordance with wireless telephone standards, such as, for example, ANSI41 and GSM. Base stations 102 preferably communicate with mobile switching centers 104 via a standard interface, such as IS-634.

Mobile switching centers 104 are any suitable switching systems with interfaces to base stations 102, SCP 108 and elements of PSTN 106. Preferably, mobile switching centers 104 conform to and communicate in accordance with known wireless telecommunications standards, such as, for example, ANSI-41. An exemplary mobile switching center is the AUTOPLEX SYSTEM 1000, which is available from Lucent Technologies Inc., Murray Hill, New Jersey. Mobile switching centers 104 communicate with elements of the PSTN 106 and SCP 108 via standard interfaces, for example, IS-93 and ANSI 41, respectively.

Provisioning and management system 112 is preferably a computer that communicates with SCP 108 via a TCP/IP or other network protocol. SCP 108 is preferably a processor-based apparatus that uses stored computer programs to implement its functions. Alternatively, SCP 108 is implemented with interface circuits, combinatorial logic and/or sequential logic. An exemplary SCP is the LUCENT ENHANCED CONTROL SERVER available from Lucent Technologies Inc., Murray Hill, New Jersey.

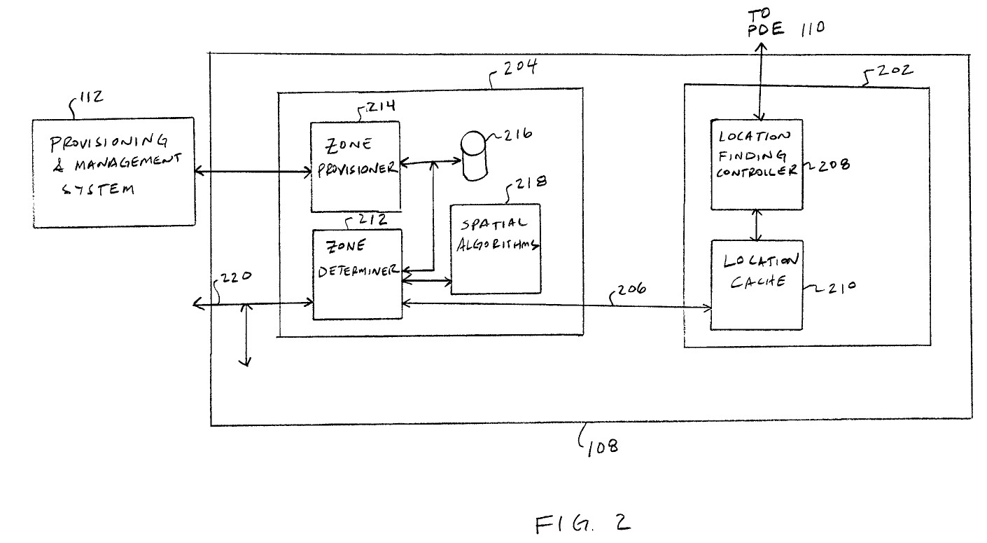

FIG. 2 is a block diagram of SCP 108 showing further details of the interface for permitting zone queries and returning geographical zone information. SCP 108 includes a location manager 202 and a zone manager 204. Location manager 202 and zone manager 204 communicate with each other over a wireless location interface 206. Location manager 204 determines the position or location coordinates of mobile units 101. This determination is preferably made by determining the appropriate technology for use by position determination equipment 110 to determine the position of the mobile units 101. Zone manager 204 enables provisioning of geographical zone information, determines which zone a mobile unit 101 is located in and communicates the geographical zone information to other applications.

Location manager 202 includes a location finding controller 208 and a location cache 210. Location finding controller 208 is coupled to location cache 210 for communication of data. Location finding controller 208 provides the interface to position determination equipment 120. In conjunction with the position determination equipment 120, location finding controller 208 computes a mobile unit's location and uncertainty. More specifically, location finding controller 208 (i) aggregates and distributes location queries to the position determination equipment 110; (ii) converts location data from a position determination equipment format to a location cache format; and (iii) implements the interface (hardware and drivers) for the position determination equipment 110. Location finding controller 208 is preferably implemented in the location manager 202 as shown in FIG. 2 and is alternatively implemented in the position determination equipment 110. Location cache 210 receives location coordinate data for mobile units 101 from location finding controller 208. Location cache 210 stores the location coordinate data in a database and determines which applications may require updated location coordinate data. Location cache 210 determines the “best” location data from multiple sources from position determination equipment 110.

Zone manager 204 includes a zone determiner 212, zone provisioner 214, zone database 216, and spatial algorithm 218. Zone determiner 212 interfaces to location cache 210 of location manager 202 via wireless location interface 206. Zone determiner 212 receives location or zone request from applications via a geographic layer interface 220. Zone determiner 212 also receives “best” location data from location cache 210 of location manager 202. Zone determiner 212 determines the zone a mobile unit is in based on the “best” location from the location manager and returns the geographical zone information to an application via the geographic layer interface 220. Zone determiner 212 also provides updates of a mobile unit's location and geographical zone information to an application. Zone provisioner 214 is controlled by a user to establish geographical zone information, such as network zones, specific service zones and individual or personal zones. Zone provisioner 214 is accessed by a user using provisioning management system 112. Zone database 216 stores zone data, including the relationships between services or mobile units and associated zones and the relationships between geographical coordinates and zones. Spatial algorithms 218 include algorithms used by the zone determiner 212 to determine geographical zone information and resolve ambiguities.

Geographic layer interface 220 is the means by which geographic zone information is requested by an application and returned to an application. Any suitable interface, such as, for example, a message-based interface is used for geographic layer interface 220. Preferably, geographic layer interface 220 is based on ANSI-41 and GSM wireless telephone standards and supports an open interface to other applications. Most preferably, geographical layer interface 220 uses Transaction Control Application Protocol (TCAP) messages over Signaling System 7 (SS7) networks or Internet Protocol (IP) networks.

Two messages are preferably used to implement the protocol for requesting and receiving geographical zone data—a zone query and a zone reply. The zone query is typically initiated by an application that utilizes geographical zone information. The zone response is supplied to the application by zone manager 204 after communication with location manager 202. Where ANSI-41 is employed for the geographic layer interface 220, the zone query is preferably a ServiceRequest Invoke and the zone response is preferably a ServiceRequest Return Result. The ServiceRequest Invoke and ServiceRequest Return Result are messages loosely defined in the ANSI-41 standard for requesting services or information and returning information. Where GSM is employed for the geographic layer interface 220, the zone query is preferably a HandlingInformationRequest and the zone response is preferably a HandlingInformationResult. The HandlingInformationRequest and HandlingInformationResult are messages loosely defined in the GSM standard for requesting services or information and returning information.

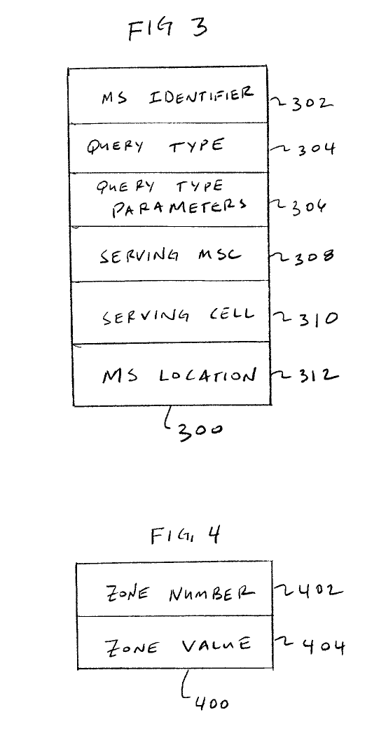

The parameters included in the zone query vary. FIG. 3 is a chart 300 showing the preferred zone query parameters. The preferred parameters include an MS identifier 302, a query type 304, query type parameters 306, serving MSC 308, serving cell 309 and MS location 310. The MS identifier 302 is a number that uniquely identifies a mobile unit 101. The query type 304 indicates the type of query sought by the request. In a preferred embodiment, three query types are supported: personal zone query, shared zone query and zone provisioning query. A personal zone query is a query relating to a zone that is determined based on the mobile unit itself. In other words the zone is personal to the mobile unit. A shared zone query is a query relating to a geographical zone shared by a group of mobile units, including a group consisting of all mobile units. An example of a shared zone is a zone based on zip codes. A zone-provisioning query is a request to establish a personal zone. The query type parameters 306 vary based on the query type and include certain parameters associated with the query type. For example, a personal zone query may include parameters used to resolve conflicts in determining the zone. In the case of a shared zone query, the query type parameters 306 may identify the type of shared zone, for example, zip code zone. The query type parameters for a zone-provisioning query may include, for example, the latitude, longitude, and a radius to define a circular personal zone. The serving MSC 308 identifies the mobile switching center currently serving the mobile unit identified by the MS identifier 302. The serving cell 309 identifies, if known, the cell and sector currently serving the mobile unit identified by the MS identifier 302. MS location 310 identifies, if known, the latitude, longitude and uncertainty of the mobile unit identified by MS identifier 302.

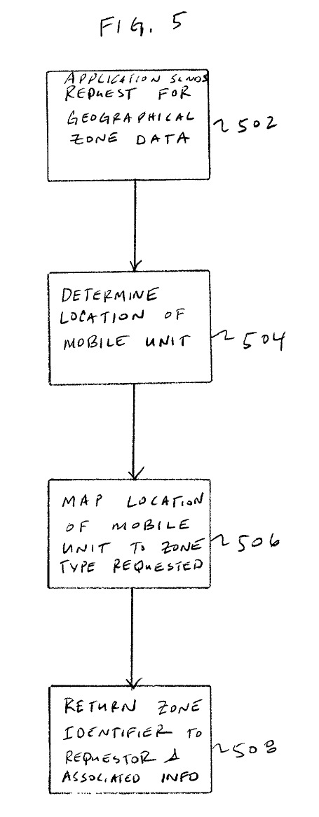

The parameters included in the zone response vary. FIG. 4 is a chart 400 showing the preferred zone response parameters. The zone response parameters include a zone number 402 and a zone value 404. Zone number 402 is a number that identifies the zone in the context of the zone query. Zone value 404 is a short text string associated with the zone number 402. Zone value 404 may be used as an index to further data in the requesting application. In the case where a zone query is a shared zone query type requesting a zip code zone, the responsive zone response may include as zone number 402 the value 60566 and as zone value 404 the text string “Lucent Naperville campus.”

The general operation of the preferred embodiment of the invention is described below with respect to FIG. 5, which is a flow chart. Operation begins with a zone query or request for geographical zone data (502). The request is initiated by an application that needs geographic data for a particular mobile unit. An example application is call processing on a mobile switching center handling a telephone call for a mobile unit, where the mobile unit is billed based on location of the mobile unit at the time the call is initiated. The application may be executing on SCP 108 or on another system. The zone query or request is preferably a digitally encoded message with the parameters of chart 300. Zone manager 204 receives the request via geographic layer interface 220.

After a request or zone query is received (502), then the location of the mobile unit identified in the zone query is determined, if not known (504). Zone manager 204 receives the request and uses zone determiner 212 to request the location of the mobile unit. Zone determiner 212 communicates with location manager 202 via wireless location interface 206 to determine the location of the mobile unit, if the location of the mobile unit was not provided with the zone query. Location manager 202 uses location finding controller 208, location cache 210, and position determination equipment 210 to determine a present location of the mobile unit.

The location of the mobile unit is returned to the zone manager via the wireless location interface 206. The location is then mapped to the zone type requested (506). More specifically, zone manager 204 uses zone determiner 212 and spatial algorithms 218 to determine the zone based on the location from the location manager and the provisioned zones stored in zone database 216. For example, location manager 202 returns coordinates for the location and an uncertainty associated with the coordinates. Then, zone determiner 212 compares the coordinates and uncertainty to data stored in the zone database to determine which zone(s) is applicable. Spatial algorithms 218 are applied as required to resolve conflicts in the coordinate data that might place the mobile in more than one zone. Finally, zone determiner 212 assigns a certain zone to the location of the mobile unit.

After the zone is determined (506), the zone response is provided to the requesting application. Preferably, the zone response is a digitally encoded message having the parameters shown in chart 400 of FIG. 4. The geographic zone data is then used by the application, for example, to determine billing for a call.

There are numerous applications that can take advantage of the geographical zone data provided in accordance with the present invention. A few exemplary applications are outlined below. First, wireless applications that use location sensitive billing may use the present invention to determine a billing zone for initiation or during a call. A prepaid wireless application may use current location to determine billing and supply the location of nearby replenishment centers for adding prepaid minutes, for example, if prepaid minutes are nearing depletion. A wireless private virtual network may use location to authorize or prevent all calls, certain calls or determine billing. In any of these applications the calling or called devices location may be used. Also, the “calls” may be voice or data calls, or both.

An advantage provided by the present invention is the ability to abstract and separate the position determination component of a geographic enabled application from the application itself. That is, rather than force each geographic-enabled application to convert coordinate or other location data to a form suitable for the application, the present invention provides an open interface that is accessible by the application to provide actual zone, versus simply coordinate data, for use by the application.

The invention being thus described, it will be evident that the same may be varied in many ways. Such variations are not to be regarded as a departure from the spirit and scope of the invention and all such modifications are intended to be included within the scope of the appended claims.

1. A method for obtaining geographical zone data for a mobile subscriber unit, the method comprising the steps of:
A) receiving a request from an application for geographical zone data for the mobile subscriber unit, wherein the request includes:
a mobile subscriber identifier that is associated with the mobile subscriber unit; and
a zone type that identifies a type of predetermined geographical area; and
B) returning a reply to the request, wherein the reply includes: a zone identifier that identifies a current geographical area where the mobile subscriber unit is located and the current geographical area has the zone type included in the request.

2. The method of claim 1 wherein the request further includes:
a switching center identifier that identifies the mobile switching center serving the mobile subscriber unit.

3. The method of claim 1 wherein the request is a transaction control application protocol message and the reply is a transaction control application protocol message.

4. The method of claim 3 wherein the request is received over one of a Internet protocol network and a signaling system seven network and the reply is returned over one of a Internet protocol network and a signaling system seven network.

5. The method of claim 4 wherein the request is received via a message defined by one of an ANSI41 and a GSM standard.

6. The method of claim 1 wherein the mobile subscriber unit comprises one of a wireless telephone, personal digital assistant, and computer.

7. The method of claim 1 wherein the mobile subscriber unit is at least one of a voice communications device and a data communications device.

8. The method of claim 1 wherein the zone type identifies one of a personal zone and a shared zone.

9. The method of claim 1 wherein the zone type comprises a request to create a zone.

10. The method of claim 1 wherein the reply includes a text string associated with the zone identifier.

11. A telecommunications network apparatus comprising:
means for receiving a request for geographical zone data for a mobile subscriber unit, wherein the request includes:
a mobile subscriber identifier that is associated with the mobile subscriber unit; and
a zone type that identifies a type of predetermined geographical area;
means for returning a reply to the request, wherein the reply includes: a zone identifier that identifies a current geographical area where the mobile subscriber unit is located and the current geographical area has the zone type included in the request.

12. The apparatus of claim 11 wherein the request further includes:
a switching center identifier that identifies the mobile switching center serving the mobile subscriber unit.

13. The apparatus of claim 12 wherein the request is a transaction control application protocol message and the reply is a transaction control application protocol message.

14. The apparatus of claim 13 wherein the request is received over one of a Internet protocol network and a signaling system seven network and the reply is returned over one of a Internet protocol network and a signaling system seven network.

15. The apparatus of claim 14 wherein the request is received via a message defined by one of an ANSI41 and a GSM standard.

16. The apparatus of claim 11 wherein the zone type identifies one of a personal zone and a shared zone.

17. The apparatus of claim 11 wherein the zone type comprises a request to create a zone.

18. The apparatus of claim 11 wherein the reply includes a text string associated with the zone identifier.

19. A telecommunications network apparatus comprising:
a geographical layer interface that receives a request for geographical zone data for a mobile subscriber unit, wherein the request includes:
a mobile subscriber identifier that is associated with the mobile subscriber unit; and
a zone type that identifies a type of predetermined geographical area; and
wherein the geographical layer interface returns a reply to the request, wherein the reply includes: a zone identifier that identifies a current geographical area where the mobile subscriber unit is located and the current geographical area has the zone type included in the request.

20. The apparatus of claim 19 further comprising:
a zone manager coupled to the geographical layer interface to receive the request;
a location manager coupled to the zone manager to deliver a location of the mobile subscriber unit as determined by a position determination equipment; and
wherein the zone manager uses the location of the mobile subscriber unit and a database of zone data to determine the zone identifier.
